(19) United States
(12) Patent Application Publication
(10) Pub. No.: US 2006/0238565 A1
(43) Pub. Date: Oct. 26, 2006

(54) Inkjet image forming apparatus that reduces image quality degradation

(75) Inventors: Sung-june Jung, Suwon-si (KR); Masahiko Habuka, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., LTD., Suwon-si (KR)

(21) Appl. No.: 11/359,495

(22) Filed: Feb. 23, 2006

(30) Foreign Application Priority Data
Apr. 26, 2005 (KR) 2005-34571

(51) Int. Cl. B41J 23/00

(52) U.S. Cl. 347/37

(57) ABSTRACT

An inkjet image forming apparatus to reduce an effect of missing or inoperable nozzles by ejecting ink at an oblique direction with respect to a direction along which paper is transferred through the apparatus using a print head that executes a reciprocal pendulum movement. The inkjet image forming apparatus reduces the effect of the missing or inoperable nozzles on the image quality by causing the obliquely mounted print head to move in reciprocal pendulum movements.

### CROSS-REFERENCE TO RELATED APPLICATIONS

This application claims the benefit of Korean Application No. 2005-34571, filed Apr. 26, 2005, in the Korean Intellectual Property Office, the disclosure of which is incorporated herein by reference.

### BACKGROUND OF THE INVENTION

1. Field of the Invention

An aspect of the present invention relates to an inkjet image forming apparatus, and, more particularly, to a line printing type inkjet image forming apparatus that reduces image quality degradation caused by missing or inoperable nozzles.

2. Description of the Related Art

An inkjet image forming apparatus forms images by ejecting ink from a print head which is suspended above a piece of paper and reciprocates perpendicularly to the direction of travel of the paper. An image forming apparatus that operates this way is called a shuttle type inkjet image forming apparatus. A nozzle unit, in which a plurality of nozzles are formed, is mounted in a print head of the shuttle type inkjet image forming apparatus.

Recently, attempts have been made to increase print speed by using a print head having a nozzle unit that has a length corresponding to a width of a piece of paper, instead of a print head traveling reciprocally across the width of the piece of paper have been attempted. An image forming apparatus that operates this way is called a line printing type inkjet image forming apparatus. In the line printing type inkjet image forming apparatus, the print head is fixed while the paper is transferred. Accordingly, a simple driving device may be used, and a high print speed is possible.

FIG. 1 is a schematic diagram of a printing pattern of a conventional inkjet image forming apparatus when a nozzle unit thereof is missing or inoperable. FIGS. 2A through 2D are pixel images illustrating a method of compensating for a missing or inoperable nozzle unit in a conventional inkjet image forming apparatus.

Referring to FIG. 1, an inkjet image forming apparatus forms an ink image on a sheet of paper using ink I that is ejected from nozzles 302 included in a conventional nozzle unit 300. The conventional nozzle unit 300 is mounted so as to be perpendicular to a paper transfer direction, and forms an image on a piece of paper by ejecting ink onto the paper. When a nozzle 304 is missing or inoperable, a missing line I₁ appears on the paper since the missing or inoperable nozzle 304 does not eject ink I. When a nozzle 304 or a plurality of nozzles 304 are missing or inoperable, white lines of missing color appear on the paper, corresponding to the missing or inoperable nozzle(s) 304. The white lines affect the printed image quality since they are easily seen.

In the shuttle type inkjet image forming apparatuses, an overlapping printing method, in which a carriage is reciprocated several times, is used to compensate for the image quality degradation caused by missing or inoperable nozzles. This method is known as a shingling method. In the line printing type inkjet image forming apparatus, the print head is mounted so as to be perpendicular to the paper transfer direction, and does not travel reciprocally across the paper, as noted above. That is, in the line printing type inkjet image forming apparatuses, there is a region where one nozzle must print one dot at a particular moment. The size of the region depends on the resolution. If the nozzle does not print, or malfunctions at the particular moment of printing, as depicted in FIG. 1, the printed image quality is degraded due to the generation of a white line. A method of compensating for the image quality degradation due to the missing or inoperable nozzle has been disclosed in U.S. Pat. No. 5,581,284. FIGS. 2A through 2D are copies of FIGS. 3 through 6 of the '284 patent.

The '284 patent discloses a method of compensating for the effect of a failed nozzle in a line printing type inkjet image forming apparatus when the failed nozzle does not print. The term “failed nozzle” refers to a nozzle that does not appropriately eject ink, such as a missing, inoperable, or weak nozzle. In the above invention, when a failed black nozzle i.e. a failed nozzle 63 of black ink is detected, other colors, i.e. cyan, magenta, and yellow, are sequentially printed on the region of the paper where the failed nozzle 63 should have printed. This process is depicted in FIGS. 2B through 2D. In this way, by printing cyan, magenta, and yellow on the same location of the paper, the color black may be approximately expressed. This process is called a process black or a composite black process. However, although this method is useful in operations in which compensating for a black nozzle is necessary, the process cannot compensate for other color nozzles. Also, when only the color black is printed, a process black may be formed using other color nozzles since the cyan, magenta, and yellow nozzles are not in operation at that time. However, when an image having cyan, magenta, and yellow colors is printed, the black nozzle cannot be compensated for by the cyan, magenta, and yellow nozzles, since these other color nozzles are in operation. Also, when one of the three compensating nozzles fails, the color is compensated by other colors, such as red (yellow+magenta), green (cyan+yellow), or blue (cyan+magenta), in contrast to the process black so as to degrade the printed image quality.

### SUMMARY OF THE INVENTION

An aspect of the present invention provides an inkjet image forming apparatus that minimizes the effect of missing or inoperable nozzles on the image quality even if some of the nozzles included in a print head are missing or inoperable.

According to an aspect of the present invention, there is provided an inkjet image forming apparatus, comprising: a print head, including a nozzle unit having a length corresponding to a width of a piece of paper, obliquely mounted at a predetermined angle with respect to a direction along which the paper is transferred through the apparatus; and a head rotation unit to cause the nozzle unit to move in reciprocal pendulum movements by rotating the print head about a longitudinal axis of the print head to eject ink in an oblique direction with respect to the paper transfer direction.

The head rotation unit may include a driving power source to rotate in forward and reverse directions; and a transmitting unit that transforms the rotary motion of the driving power source into the reciprocal pendulum movements of the nozzle unit.

The inkjet image forming apparatus may further comprise a plurality of perforated coupling units formed on the print head, and a rotation axle that supports the print head by being fixedly inserted into the perforated coupling units. The transmitting unit may include a power transmitting member that rotates the rotation axle in connection with the driving power source.

The inkjet image forming apparatus may further comprise a paper transfer unit that transfers the paper, and a control unit that synchronizes the actions of the paper transfer unit and the head rotation unit so that ink may be ejected on a desired portion of the paper.

According to another aspect of the present invention, there is provided an inkjet image forming apparatus comprising: a print head that has a nozzle unit having a length corresponding to a width of a piece of paper and is obliquely mounted at a predetermined angle with respect to the paper transfer direction; and a head rotation unit that causes the nozzle unit to move in reciprocal pendulum movements in a direction parallel to the paper transfer direction by rotating the print head about a longitudinal axis of the print head, wherein the nozzle unit is mounted at a predetermined angle with respect to the paper transfer direction to eject ink in an oblique direction with respect to the paper transfer direction.

The head rotation unit may include a driving power source that rotates forward and reverse, and a transmitting unit that transmits the rotary motion of the driving power source into a reciprocal pendulum movement of the nozzle unit. The inkjet image forming apparatus may further comprise a plurality of perforated coupling units formed on the print head, and a rotation axle that supports the print head by being fixedly inserted into the perforated coupling units. The transmitting unit may include a power transmitting member that rotates the rotation axle in connection with the driving power source. The print head may further comprise a plurality of perforated coupling units on the print head, and a rotation axle that supports the print head by being inserted into the perforated coupling units to freely rotate the print head. The head rotation unit may include an actuator that moves reciprocally in a straight line in connection with the print head to execute the reciprocal pendulum movements with respect to the rotation axle. The inkjet image forming apparatus may further comprise a linkage mechanism that transmits a reciprocal linear motion into a reciprocal pendulum movement, between the actuator and the print head.

The inkjet image forming apparatus may further comprise a paper transfer unit that transfers the paper, and a control unit that synchronizes the actions of the paper transfer unit and the head rotation unit so that ink may be ejected on a desired portion of the paper.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a printed pattern of a conventional inkjet image forming apparatus when a nozzle unit thereof fails;

FIGS. 2A through 2D are pixel images illustrating a method of compensating for a failed nozzle in a conventional inkjet image forming apparatus;

FIG. 3 is a cross-sectional view of a line printing type inkjet image forming apparatus according to an embodiment of the present invention;

FIG. 4 is a perspective view of a head driving device according to an embodiment of the present invention;

FIG. 5 is a perspective view of a coupling of the print head and the rotation axle depicted in FIG. 4;

FIG. 6 is an exploded perspective view of a head driving device according to another embodiment of the present invention;

FIG. 7 is a side view of the reciprocal pendulum movement of the print head depicted in FIGS. 4 and 6;

FIGS. 8A through 8D are bottom views of various examples of nozzle units depicted in FIG. 4;

FIG. 9 is a lateral view of a head rotation unit of the head driving device depicted in FIG. 4 according to another embodiment of the present invention;

FIG. 10 is a lateral view of a linkage mechanism mounted between an actuator of FIG. 9 and a print head;

FIG. 11 is a perspective view illustrating an ink ejecting action from the print head that executes a reciprocal pendulum movement;

FIG. 12 is pixel image of a portion of a paper onto which ink is ejected; and

FIGS. 13A through 13C are bottom views of various examples of nozzle units.

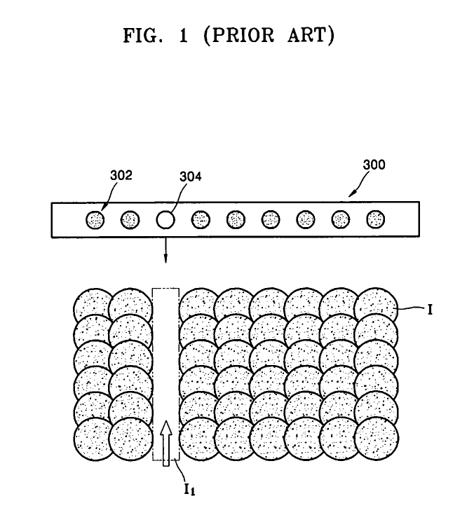

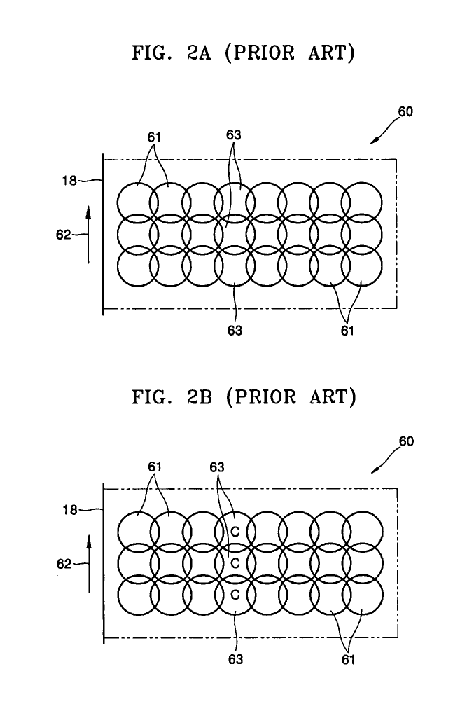

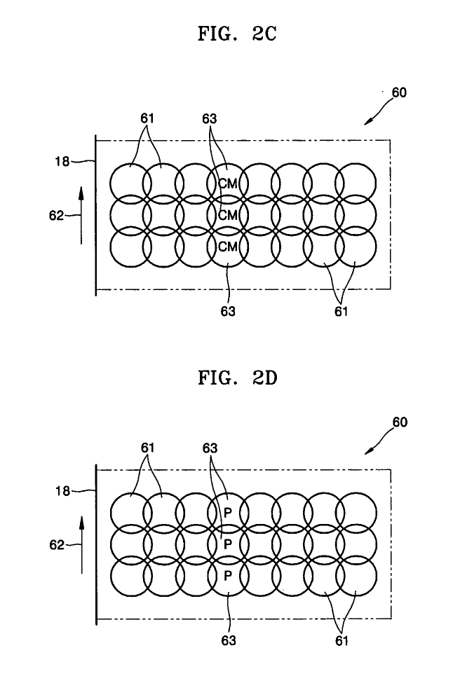

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a line printing type inkjet image forming apparatus refers to an inkjet image forming apparatus having a print head including a nozzle unit having a length that corresponds to a width of a piece of paper. Also, for convenience of explanation, the overall configuration of the inkjet image forming apparatus will be followed by a description of the head driving device. In the FIGs., some dimensions and features may be exaggerated for clarity.

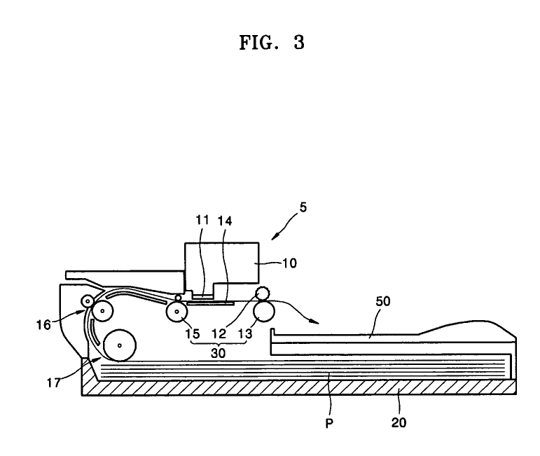

FIG. 3 is a cross-sectional view of a line printing type inkjet image forming apparatus according to an embodiment of the present invention. For convenience of explanation, the head driving device that drives the print head in reciprocal pendulum movements is omitted.

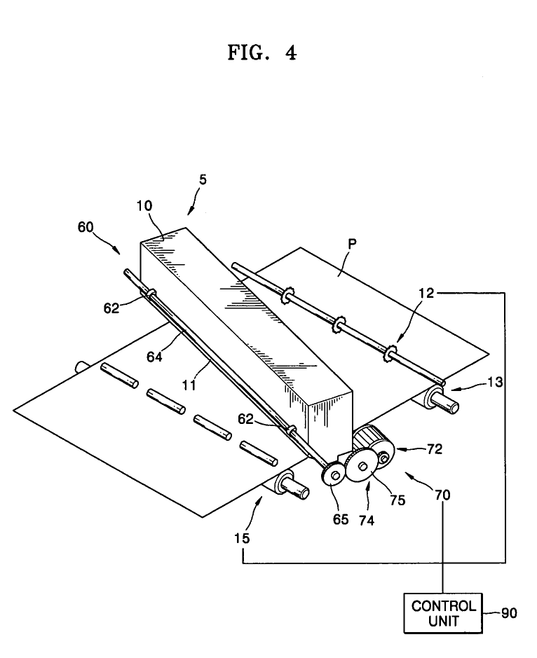

Referring to FIG. 3, an inkjet image forming apparatus includes a paper supply cassette 20, a pick-up roller 17, a head driving device 60 (see FIG. 4), a supporting member 14, a paper transfer unit 30 that transfers pieces of paper P, and a paper deck 50 on which discharged paper P is stacked.

Paper P is stacked in the paper supply cassette 20. The pick-up roller 17 is mounted on one side of the paper supply cassette 20, and picks up the sheets of paper P one by one from the paper supply cassette 20. Then, the pick-up roller 17 transfers the pieces of paper P to the outside of the paper supply cassette 20 by rotating while pressing an upper surface of the individual piece of paper P on a top of the stack of papers P.

The paper transfer unit 30 is rotated by a driving source, such as a motor, and provides a paper transferring force. The paper transfer unit 30 includes a feed roller 15 and discharge rollers 12 and 13. The feed roller 15 is mounted on an inlet of a print head 5, and transfers the pieces of paper P from the paper supply cassette 20 to the print head 5.

As the pieces of paper P are transferred to the print head 5, the feed roller 15 may perform a paper aligning operation so that ink may be ejected on desired locations on the paper P, before the paper P passes through the print head 5. The feed roller 15 may be composed of a driving roller that provides a paper transferring force and an idle roller which is elastically engaged with the driving roller.

An auxiliary roller 16 that transfers pieces of paper P may further be included between the pick-up roller 17 and the feed roller 15 to aid in the transferring of the pieces of paper P.

The paper discharging rollers 12 and 13 are mounted at an outlet of the print head 5, and discharge paper P on which an image is printed to an outside of the inkjet image forming apparatus. Pieces of paper P discharged from the inkjet image forming apparatus are stacked on a paper deck 50. The paper discharging rollers 12 and 13 include a star wheel 12 disposed in parallel to a width direction of the paper P and a supporting roller 13 that faces the star wheel 12 and supports the back side of the paper P. Wrinkles may form on a wet upper surface of the paper P onto which ink is ejected while the paper P passes through a nozzle unit 11. If the wrinkles are bad, the printed image on the paper P may be contaminated by spreading wet ink by contacting the lower surface of the nozzle unit 11 or a main body 10. Also, a gap between the paper P and the nozzle unit 11 may be changed by the wrinkles. The star wheel 12 prevents the paper P transferred under the nozzle unit 11 from contacting the lower surfaces of the nozzle unit 11 and the main body 10 and prevents the gap between the paper P and the nozzle unit 11 from changing. At least a portion of the star wheel 12 protrudes further downward than the nozzle unit 11 to contact a point on the upper surface of the paper P. Accordingly, the star wheel 12 prevents an image of wet ink on the paper P from being contaminated due to contact with the paper R Also, a plurality of star wheels may be mounted on the image forming apparatus to aid in the smooth transfer of the paper R When a plurality of star wheels are mounted on the image forming apparatus parallel to the paper transfer direction, a plurality of supporting rollers are also included so as to correspond in location to the star wheels.

The supporting member 14 is located below the print head 5 to maintain a predetermined gap between the nozzle unit 11 and the paper P, and supports the back side of the paper R The gap between the nozzle unit 11 and the paper P is approximately 0.5-2.5 mm.

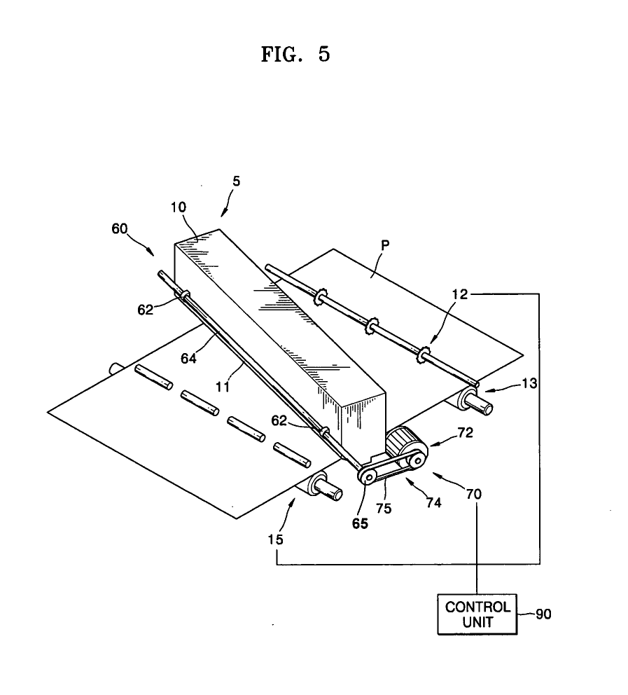

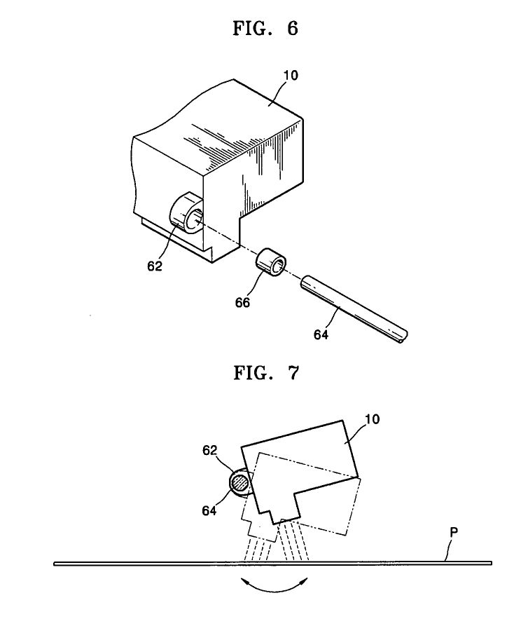

FIG. 4 is a perspective view of a head driving device according to an embodiment of the present invention, FIG. 5 is a perspective view of a coupling of the print head and the rotation axle depicted in FIG. 4, FIG. 6 is an exploded perspective view of a head driving device according to another embodiment of the present invention, and FIG. 7 shows a reciprocal pendulum movement of the print head depicted in FIGS. 4 and 6.

Referring to FIGS. 3 and 4, a head driving device 60 orients the nozzle unit 11 to eject ink at a predetermined angle with respect to an upper surface of the paper, and includes a print head 5 and a head rotation unit 70 that causes the print head 5 to rotate in reciprocal pendulum movements.

The print head 5 prints an image on a sheet of paper P by ejecting ink onto the paper P, and is mounted at a predetermined angle with respect to the paper transfer direction. The print head 5 includes the main body 10 and the nozzle unit 11, which is located on a lower surface of the main body 10. The feed roller 15 is mounted on the inlet and the star wheel 12 is rotatably mounted on the outlet of the nozzle unit 11. A plurality of nozzle arrays that eject ink from the nozzle unit are located on the nozzle unit 11. According to an embodiment of the invention, the nozzle unit 11 has a length that corresponds to or is greater than a width of the paper P. An aspect of the print head 5, according to the present invention, is that the print head 5 is a line printing type print head that prints an image by ejecting ink from the nozzle unit 11 having a length that corresponds to the width of the paper P, and is not a shuttle type print head that prints an image by ejecting ink onto the paper P while moving perpendicularly to the paper transfer direction.

A storage space (not shown) to store ink is provided in the main body 10. The main body 10 further includes a chamber which is connected to each of the nozzles of the nozzle unit 11 and has an ejecting member (such as a piezo device or a heater) that provides pressure to eject ink, and a flow channel to supply ink stored in the main body 10 to the chamber. Since the chamber, the ejecting member, and the flow channel are well known in the art descriptions thereof will be omitted.

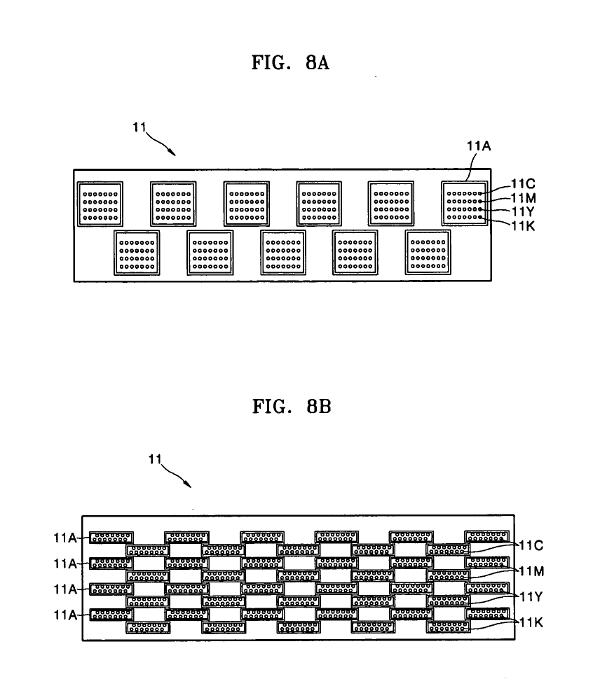

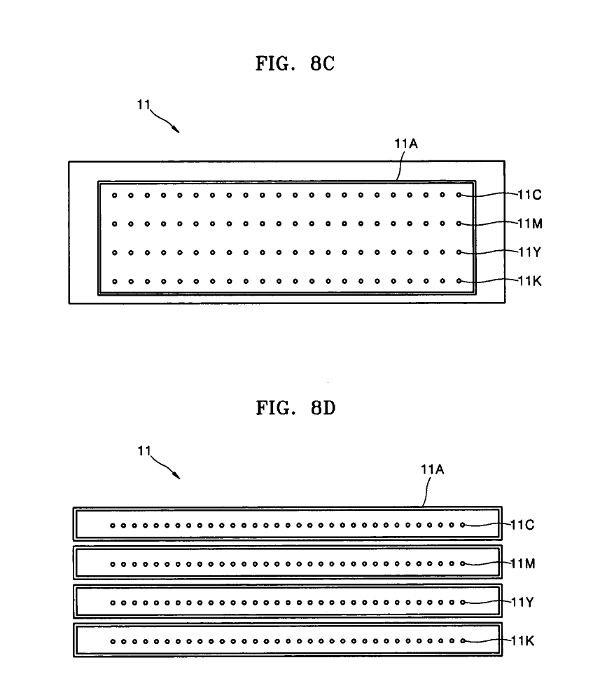

FIGS. 8A through 8D are plan views of various nozzle units 11. In the nozzle unit 11, depicted in FIG. 8A, nozzle sections 11A having a plurality of rows of nozzles 11C, 11M, 11Y, and 11K, are arranged in staggered columns along the length direction of the nozzle unit 11. In this embodiment, each of the individual nozzle sections 1A ejects ink of differing colors. In the nozzle unit 11 depicted in FIG. 8B, the nozzle sections 11A each have one row of nozzles therein. Further, the nozzle sections 1A are arranged such that those nozzle sections 1A of differing colors are arranged with respect to each other along the paper transfer direction and the nozzle sections 11A of the same color with respect to each other are arranged along the length direction of the nozzle unit 11. The nozzle unit 11 depicted in FIG. 8C comprises one nozzle section 11A having a plurality of rows of nozzles 11C, 11M, 11Y, and 11K, which have a length corresponding to the width of the paper P. In the nozzle unit 11 depicted in FIG. 8D, a set of nozzle sections 11A, each having one row of nozzles having a length corresponding to the width of the paper P, are arranged in four rows in the paper P transferring direction. Of course, it is understood that the arrangements of the nozzle units 11 depicted in FIGS. 8A through 8D are only examples, and that the nozzle units 11 may have various additional arrangements. Therefore, the technical scope of the present invention is not limited to the arrangements depicted in FIGS. 8A through 8D.

Referring to FIG. 5, perforated coupling units 62 are provided on one side of the print head 5. A rotation axle 64 is inserted into the perforated coupling units 62 to support the print head 5. At this time, the perforated coupling units 62 may be fixedly or rotatably coupled to the rotation axle 64. Also, the rotation axle 64 may be inserted into a guide bush 66 (see FIG. 6). Then, the guide bush 66, having the rotation axle 64 inserted therein, may be inserted into the coupling units 62. The rotation axle 64 is mounted on a main body frame (not shown). Also, the rotation axle 64 is coupled to a power transmission unit 65 that receives power from a driving power source. The power transmission unit 65 may be a gear or a pulley coupled to a timing belt. Also, the power transmission unit 65 may be formed as a concave-convex element formed around the rotation axle 64. Of course, it is understood that these modifications of the power transmission unit 65 are examples and do not limit the technical scope of the present invention.

Referring to FIGS. 3 and 4 again, the head rotation unit 70 rotates the nozzle unit 11 in reciprocal pendulum movements by controlling the print head 5 to eject ink in an oblique direction with respect to an upper surface of the paper. Here, the reciprocal pendulum movements denote that, as depicted in FIG. 7, the main body 10 rotates periodically by a predetermined angle about a rotation axle. The rotation is not necessarily symmetrical. Ink is obliquely ejected onto a piece of paper P when the nozzle unit 11 executes a reciprocal pendulum movement. Accordingly, even if a portion of the nozzle unit 11 is missing or inoperable, the degradation of image quality may be reduced since the effect of the missing or inoperable nozzle is distributed to other lines of printing unlike in the prior art in which ink is ejected in a direction parallel to the paper transfer direction. That is, the degradation of image quality due to white lines caused by missing or inoperable nozzles in the prior art may be reduced by the present invention.

The head rotation unit 70 is mounted on one side or on both sides of the rotation axle 64, and, includes, as depicted in FIG. 4, a driving power source 72 that rotates in forward and reverse directions and a transforming unit 74 that transforms a rotary motion of the driving power source 72 into the reciprocal pendulum movements of the nozzle unit 11, that is, the print head 5. The transforming unit 74 includes a power transmitting member 75 that rotates the rotation axle 64 in connection with the rotation of the driving power source 72. As is depicted in FIG. 4, the power transmitting member 75 may be a power transmitting gear that transmits power from the driving power source 72 to the rotation axle 64, or, as depicted in FIG. 6, may be a belt that transmits power by being supported by a driven pulley mounted on the rotation axle 64 and a driving pulley mounted on a driving axis of the driving power source 72. Of course, it is understood that the power transmitting methods according to the present invention are not limited to the examples depicted in FIG. 6.

In the present invention, the perforated coupling units 62 and the rotation axle 64 may be fixedly mounted. This is because the rotation axle 64 is rotated in forward and reverse directions by the power transmitting member 75 when the driving power source 72 rotates in forward and reverse directions. Accordingly, the print head 5 being fixedly coupled to the rotation axle 64 also executes the reciprocal pendulum movements, as depicted in FIG. 7, in connection with the forward and reverse rotation of the driving power source 72.

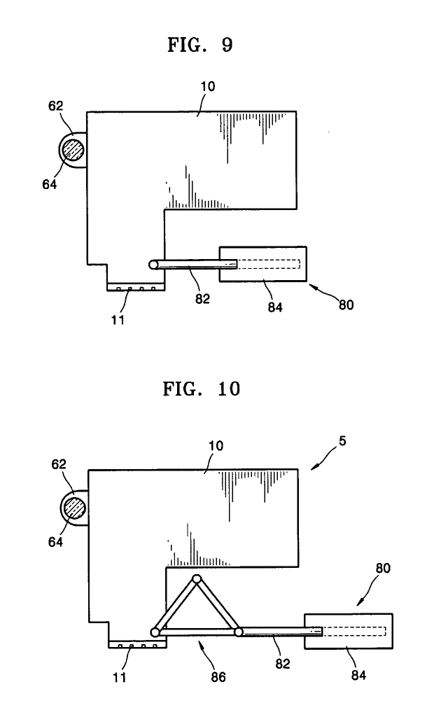

FIG. 9 is a lateral view of another embodiment of a head rotation unit of the head driving device than that which is depicted in FIG. 4, and FIG. 10 is a lateral view illustrating an embodiment of a linkage mechanism mounted between an actuator and a print head. For convenience of explanation, like reference numerals refer to like elements having equivalent operations and effects as in the previous embodiments.

Referring to FIG. 9, the head rotation unit includes an actuator 80 to reciprocate in a straight line. The actuator 80 includes a cylinder unit 84 that is mounted on the main body frame (not shown) and a piston unit 82 that slides into the cylinder unit 84. One end of the piston unit 82 is coupled to the print head 5. Accordingly, when the piston unit 82 reciprocates in the cylinder unit 84, the print head 5 executes a corresponding reciprocal pendulum movement around the rotation axle 64. Of course, it is noted that if the rotation axle 64 and the perforated coupling units 62 are coupled in such a way that the print head 5 freely rotates, the print head 5 will not tend to execute a reciprocal pendulum movement with respect to the rotation axle 64, whereas, when the rotation axle 64 is fixedly inserted into the perforated coupling units 62, the rotation axle 64 and the print head 5 move as a single body, and, accordingly, the print head 5 executes a reciprocal pendulum movement by the rotation of the rotation axle 64.

Referring to FIG. 10, an embodiment in which a linkage mechanism 86 that transforms a reciprocal linear motion to a reciprocal pendulum movement that may be further included between the actuator 80 and the print head 5 is shown. As shown in FIG. 10, a three-bar linkage mechanism is possible, but it is understood that various modifications, such as a four-bar linkage mechanism or a five-bar linkage mechanism, may be employed. The actuator 80 may be a piezo-actuator which may precisely control a location of the print head 5. Since the configuration and operation of the actuator 80 are well known in the art, a detailed description thereof will be omitted. Also, a hydraulic cylinder or an air cylinder may be employed as the head rotation unit instead of the actuator 80.

As is described above, the head rotation unit 70 causes the nozzle unit 11 to move in reciprocal pendulum movements to eject ink in an oblique direction with respect to the paper transfer direction by controlling the print head 5. Accordingly, the ink is ejected to form an oblique line on the paper P unlike in the prior art. A control unit 90 synchronizes the actions of the paper transfer unit 30 and the head rotation unit 70 to eject ink onto a desired portion of the paper P. That is, the control unit 90 controls the action of the head rotation unit 70 in harmonization with the transfer speed of the paper P so that the ink ejected in the oblique direction may be ejected onto a desired portion of the paper P.

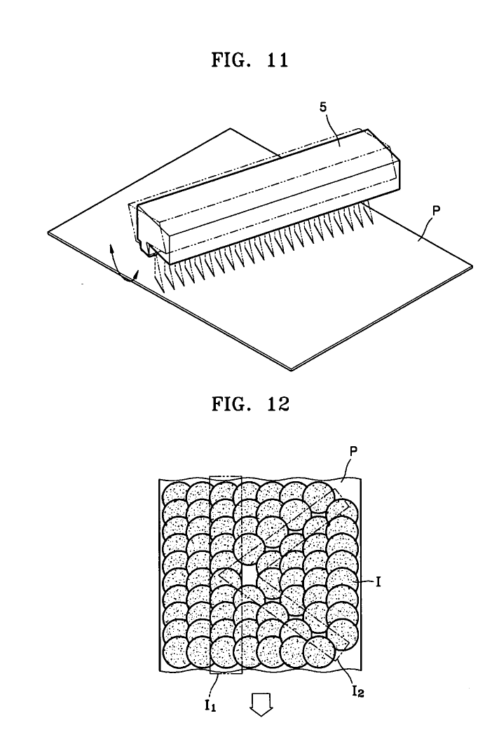

The image forming process of an inkjet image forming apparatus according to the present invention will now be described with reference to FIGS. 11 and 12. FIG. 11 is a perspective view illustrating an ink ejecting action of the print head 5 that executes a reciprocal pendulum movement, and FIG. 12 is an enlarged plan view of a portion of the paper P onto which ink is ejected.

Referring to FIGS. 11 and 12, the print head 5 ejects ink I, and at the same time, executes a reciprocal pendulum movement about a longitudinal axis of the print head 5. Here, the print head 5 that executes the reciprocal pendulum movement is driven by a driving power source 72 and/or an actuator 80. Also, when the print head 5 executes a reciprocal pendulum movement, ink is ejected to form an oblique line on the paper P since the print head 5 is obliquely mounted at a predetermined angle with respect to the paper transfer direction. Since the print head 5 executes a reciprocal pendulum movement and ejects ink I while the paper P moves at a predetermined speed, the ink I ejected from one nozzle adheres to the paper P in a zigzag shape, as depicted in FIG. 12.

An effect of a missing or inoperable nozzle is depicted in FIG. 12. That is, the ink I is not ejected on a region indicated by I₂ in FIG. 12. In the prior art, when ink I is not ejected due to a missing or inoperable nozzle, a white line indicated by I₁ in FIG. 12 appears on the paper P. However, in the present invention, the effect of the missing or inoperable nozzle is distributed to other lines in a zigzag shape. That is, the effect of the missing or inoperable nozzle is effectively distributed to an almost invisible level by an error diffusion method.

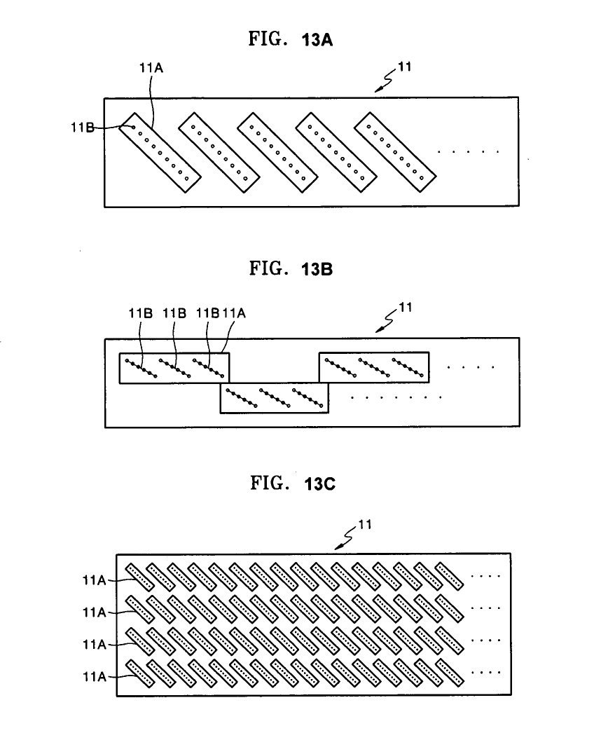

FIGS. 13A through 13C are bottom views of various examples of nozzle units. For convenience of explanation, like reference numerals refer to like elements having equivalent operations and effects as in the above embodiment.

The print head 5 is mounted so as to be perpendicular to the paper transfer direction, and has a nozzle unit 11 having a length corresponding to the width of a sheet of paper P. Here, as depicted in FIG. 13A through 13C, the nozzle unit 11 is mounted obliquely at a predetermined angle with respect to the paper transfer direction, to eject ink at an oblique angle from the paper transfer direction.

In the nozzle unit 11 depicted in FIG. 13A, nozzle sections 11A each have a row of nozzles 11B, and are obliquely arranged in the length direction of the nozzle unit 11. In the nozzle unit 11 depicted in FIG. 13B, the nozzle sections 11A each have a plurality of rows of nozzles 11B formed in an oblique line, and are arranged in two staggered columns. In the nozzle unit 11 depicted in FIG. 13C, four columns of the nozzle sections 11A are each arranged to be oblique to the paper transfer direction. Each of the nozzle sections 11A ejects a different color of ink (for example, cyan, magenta, yellow, and black). Of course, it is understood that the nozzle units 11, depicted in FIGS. 13A through 13C are only examples, and that various shapes of the nozzle unit 11 may be employed. It is also understood that the technical scope of the present invention is not limited to the configurations of the nozzle unit 11 depicted in FIGS. 13A through 13C.

According to the configurations described above, the present invention, unlike in the prior art, reduces an effect of missing or inoperable nozzles by ejecting ink at an oblique angle to a paper transfer direction using a print head that executes a reciprocal pendulum movement.

As is described above, the inkjet image forming apparatus according to the present invention, unlike in the prior art, reduces an effect of missing or inoperable nozzles on the image quality by causing the obliquely mounted print head to move in reciprocal pendulum movements. Alternatively, the present invention reduces an effect of the missing or inoperable nozzles on the image quality by causing the print head, having obliquely arranged nozzle rows, to move according to the reciprocal pendulum movements. That is, the present invention minimizes the effect of the missing or inoperable nozzles on the image quality by effectively distributing the effect of the missing or inoperable nozzles, even if some of the nozzles included in the print head are missing or inoperable.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An inkjet image forming apparatus, comprising:
a print head, including a nozzle unit having a length corresponding to a width of a piece of paper, obliquely mounted at a predetermined angle with respect to a direction along which the paper is transferred in the apparatus; and
a head rotation unit to cause the nozzle unit to move in reciprocal pendulum movements by rotating the print head about a longitudinal axis of the print head to eject ink in an oblique direction with respect to the paper transfer direction.

2. The inkjet image forming apparatus of claim 1, wherein the head rotation unit includes:
a driving power source to rotate in forward and reverse directions; and
a transmitting unit that transforms the rotary motion of the driving power source into the reciprocal pendulum movements of the nozzle unit.

3. The inkjet image forming apparatus of claim 2, further comprising:
a plurality of perforated coupling units formed on the print head; and
a rotation axle that supports the print head when fixedly inserted into the perforated coupling units.

4. The inkjet image forming apparatus of claim 3, wherein the transmitting unit includes a power transmitting member to rotate the rotation axle in accordance with the rotation of the driving power source.

5. The inkjet image forming apparatus of claim 1, further comprising:
a plurality of perforated coupling units on the print head; and
a rotation axle that supports the print head when inserted into the perforated coupling units to freely rotate the print head.

6. The inkjet image forming apparatus of claim 5, wherein the head rotation unit includes an actuator to reciprocate in a straight line in connection with the print head to execute the reciprocal pendulum movements with respect to the rotation axle.

7. The inkjet image forming apparatus of claim 6, further comprising a linkage mechanism, between the actuator and the print head, to transform the reciprocal motion of the actuator into a corresponding reciprocal pendulum movement of the print head.

8. The inkjet image forming apparatus of claim 1, further comprising:
a plurality of perforated coupling units formed on the print head; and
a rotation axle that supports the print head when fixedly inserted into the perforated coupling units.

9. The inkjet image forming apparatus of claim 8, wherein the head rotation unit comprises an actuator to reciprocate in a straight line in connection with the print head to rotate the rotation axle.

10. The inkjet image forming apparatus of claim 9, further comprising a linkage mechanism, between the actuator and the print head, to transform the reciprocal motion of the actuator into a corresponding reciprocal pendulum movement of the print head.

11. The inkjet image forming apparatus of claim 1, further comprising:
a paper transfer unit to transfer the paper through the apparatus; and
a control unit to synchronize the actions of the paper transfer unit and the head rotation unit so that ink may be ejected on a desired portion of the paper.

12. A print head driving device of an image forming apparatus, comprising:
a print head, to eject ink onto a piece of paper being transferred through the apparatus, the print head being mounted at a predetermined angle with respect to a direction along which the paper is transferred; and
a print head rotation unit to rotate the print head about a longitudinal axis of the print head to cause the print head, when ejecting the ink onto the piece of paper, to eject the ink at an oblique angle with respect to the paper transfer direction.

13. The device according to claim 12, wherein the print head comprises:
a main body to store the ink; and
a nozzle unit, located on a lower surface of the main body, including a plurality of nozzle sections that eject the stored ink from the nozzle unit.

14. The device according to claim 13, wherein the nozzle sections each comprise rows of nozzles to each eject different colored ink, the nozzle sections being arranged in staggered columns along a length of the nozzle unit.

15. The device according to claim 13, wherein the nozzle sections each comprise a single row of nozzles to eject ink of a certain color, with the nozzle sections being arranged such that those nozzle sections to eject ink of differing colors are arranged along the paper transfer direction and the nozzle sections to eject ink of the same color are arranged along the length direction of the nozzle unit.

16. The device according to claim 12, wherein the print head comprises:
a main body to store the ink; and
a nozzle unit, located on a lower surface of the main body, including a nozzle section that ejects the stored ink from the nozzle unit, wherein the nozzle section comprises rows of nozzles to eject ink of a particular color and columns of nozzles to eject ink of differing colors.

17. The device according to claim 13, wherein the nozzle sections comprise a row of nozzles to eject ink of a particular color, the nozzle sections being arranged in a single column.
